(19) United States
(12) Patent Application Publication
(10) Pub. No.: US 2024/0101080 A1
(43) Pub. Date: Mar. 28, 2024

(54) SYSTEM AND METHOD FOR THE AUTOMATIC DEPLOYMENT OF A PARK CONTROL VALVE IN AN AIR BRAKING VEHICLE

(71) Applicant: David Oberheu, Stone Mountain, GA (US)

(72) Inventor: David Oberheu, Stone Mountain, GA (US)

(21) Appl. No.: 17/935,228

(22) Filed: Sep. 26, 2022

(51) Int. Cl. B60T 7/16; B60T 13/68; B60T 15/02

(52) U.S. Cl. CPC B60T 7/16; B60T 13/683; B60T 15/027; B60T 2201/10

(57) ABSTRACT

A system for remote actuation of a parking brake upon a driver exit of a specially-equipped vehicle. The system includes a control module having a pressure-releasing valve which can be opened and closed between an air braking system and parking brake control button. Vehicles with a parking brake control button coupled to an air braking system engage a parking brake upon a drop in pressure of the system to a specified point. Upon a driver's exit of the vehicle, the control valve opens the pressure-releasing valve, causing the control valve to engage the vehicle parking brake. A remote actuation device configured to be with the driver of the vehicle and to indicate to the module when the driver exits the vehicle such that the module causes the air braking system to set the parking brake if not already set. A method of automatically engaging a vehicle parking brake.

### FIELD OF THE DISCLOSURE

The present disclosure generally relates to the safety of vehicles having an air braking system. More specifically, the present disclosure relates to modifications to such air braking systems to enable the automatic actuation and/or deployment of an air brake.

The present disclosure is not limited to any particular vehicle or means of conveyance.

### BACKGROUND

Serious hazards are associated with unattended motor vehicles. One such hazard may be vehicle movement due to failure of the vehicle operator to properly set the parking brake. Even if a parking brake is set, an unauthorized person such as a thief or a child could access the vehicle, disengage the parking brake, and place the vehicle in gear. Such inadvertent vehicle movement frequently results in damage to the vehicle or other property due to collision and, more seriously, can result in injury or even death to bystanders.

Particularly heavy vehicles, such as buses, tractor-trailers, semi-trucks, shuttles, and the like may be generally equipped with air brakes. In vehicles, especially those heavy enough and equipped with air brakes, a driver must use caution in exiting the vehicle to ensure that the parking brake of the vehicle is set when the driver exits the cab. Such safety precautions are always recommended but may often be required in order to prevent rollaway accidents, typically by local, state, or federal regulations of commercial drivers and their vehicles. Additionally, theft may be prevented and/or deterred by the implementation and use of a parking brake system, especially one which may be only deactivated when a vehicle has been engaged by an authorized driver (i.e., someone with a key to the vehicle ignition). However, as is often the case with drivers leaving a vehicle, people can forget to perform even simple and/or routine tasks, even when those simple tasks may cause enormously important consequences if not performed.

Various automatic braking devices, systems and methods have been developed to address the problem of unwanted movement of unattended vehicles. These devices and methods typically apply the parking brakes when the vehicle operator has left the driver seat of the vehicle. Many such systems additionally employ a time delay so that temporary loss of weight in the driver seat due to travel over bumps or irregular terrain does not activate the braking system. Other safety systems are equipped to prevent release only (i.e., they may not automatically deploy the parking brake, but prevent its disengagement) employ electronic interlocks on the driver's seatbelt and the driver's side door to determine whether an occupant is belted before allowing the release of the parking brake. In nearly all implementations of a vehicle parking brake system, the automatic deployment (or prevention of disengagement) is engaged using an electronic system, the parts of which could fail. Furthermore, many require the additional installation of aftermarket parts and accessories, which may be difficult or expensive to install, maintain, and repair. Since they do not rely in a large part on standard vehicle equipment, and due to variations in vehicle configuration, it is often very complicated and frustrating for vehicle owners to maintain a fleet which incorporates this important safety and theft prevention feature, thereby leading to many vehicles lacking such a feature.

Standard vehicles featuring an air braking system may typically be equipped with an automatic low-pressure pop-up feature. In cases where the air pressure supplied to the parking valve is reduced below a specific pressure (e.g., 30 psi), the park control knob may be configured to pop up and engage the parking brake. While this low-pressure pop-up system which may be found in many vehicles equipped with air brakes is distinct from its parking brake system, both systems share their ability to slow down or prevent the movement of vehicles. However, no system is known which links these two related systems so as to accomplish an automatic deployment of a park control valve in vehicles equipped with an air braking system upon a vehicle driver exit of the vehicle.

The instant disclosure may be designed to address at least certain aspects of the problems or needs discussed above by providing such a system specialized for the purpose of diverting air pressure to the park control valve in vehicles equipped with air brakes. By providing such a system, a driver may reliably depend on automatic systems for engaging the parking brake through utilization of existing, often standard, vehicle equipment along with the systems and methods of this disclosure.

### SUMMARY

The present disclosure may solve the aforementioned limitations of the currently available automatic parking brake systems by providing a system and method for the automatic deployment of a park control valve in an air braking vehicle.

Accordingly, in one aspect, the present disclosure embraces the simplicity that may be achieved through the unification of existing vehicle braking and braking control systems. An air braking system which may be generally engaged during transit, often at high speeds, in order to slow and/or stop the vehicle may be the most important safety feature of many commercial and industrial vehicles because it offers the driver the ability to stop his or her vehicle before encountering an obstacle which it may strike. A park braking system may be similarly important in that it prevents a parked vehicle, which may be heavy, from rolling down an incline. Furthermore, the parking brake may be a brake of last resort in a case where pressure is suddenly lost in an air braking system due to failure (e.g., puncturing of a pressure line) such that a driver may competently slow the vehicle to a stop and seek repair of the air braking system. In fact, as may often be standard in modern heavy vehicles equipped with air brakes, automatic systems may deploy in cases of sudden pressure drop within the air braking system. These automatic systems may cause the park control knob, which in turn controls the parking brake, to pop up and engage the parking brake to slow the vehicle to a stop in such an emergency scenario. By electronically associating the presence of a driver with the pressure in the air braking system, this pop-up braking system may be engaged automatically when the driver is no longer detected (i.e., has left the seat, vehicle, etc.).

In one embodiment of the disclosed automatic parking brake system for a vehicle having an air braking system, the vehicle is equipped with an air braking system in pneumatic combination with an air pressure supply, a parking brake, and a park brake control button. Within such a vehicle, a control module capable of controlling a pressure-releasing valve may be installed therebetween the air pressure supply and the park brake control button and the control module is configured to open the pressure-releasing valve subsequent a driver's exit from the vehicle, causing the park brake control button to apply the parking brake. The park brake control button may be configured to engage the parking brake upon a decrease in air pressure within the air braking system which could occur when air pressure is 30 psi or below.

In another aspect, the present disclosure may utilize various electronic components to detect the presence of a driver, thereby activating the system and method of the disclosure when the driver is not present. This may be achieved through the manufacture, use, and implementation of an Radio Frequency Identification (RFID) chip, an RFID sensor, a control module, and an air valve having electronic control capabilities. Together, the RFID chip may be configured to engage the RFID sensor to recognize and/or authorize the holder of the RFID chip (e.g., the driver) to engage the remaining systems. Other similar wireless systems and standards may also be employed, and the disclosure is not limited to any specific standard or system. When, for example, a driver bearing the specially configured RFID chip is proximate the RFID sensor, a normal driving mode may be engaged. When a driver bearing this chip is no longer proximate the sensor, a deploy signal may be sent by the control module to the electronically controlled air pressure supply valve, which may then cut off the supply of compressed air to the park control valve, venting it out from the park control valve and thereby engaging the low-pressure pop-up feature thereof, and engaging the parking brake.

In a potentially preferred embodiment of the disclosure, the system may feature a control module capable of sending a signal to the electronically controlled air pressure supply valve. The electronically controlled air pressure supply valve may direct compressed air to the park brake control button in drive mode, but in deploy mode, may instead cut off the air supply to the system, vent air pressure from the park control valve, and result in actuating the emergency pop-up feature to engage the parking brake. In a potentially preferred embodiment of the control module, it may further feature the RFID chip and sensor pair. When proximate, the emergency system does not engage, and the parking brake can be freely engaged and/or disengaged. When the pair is distant, the control module activates the remaining aspects of the disclosure to achieve the intended results.

In alternate embodiments of the disclosed system and method for the automatic deployment of a park control valve in an air braking vehicle, various other features may be present. For instance, the system may also feature an on/off switch. Such a switch may engage or disengage the automatic system for cases where driver presence may not be desired (e.g., during towing). The on/off switch may be paired with or otherwise incorporate an authenticating feature, such as a keypad which may allow the driver to enter a code to disengage the automatic system. Additionally, the system and method for the automatic deployment of a park control valve in an air braking vehicle may be appended to an existing vehicle system or alternatively be incorporated into such a system during vehicle manufacture. Just as the RFID chip may be incorporated into a vehicle key or fob, or include a hole or aperture capable of receiving a key ring, to avoid needing to carry the chip separately from the vehicle key, the cylinders of the park control valve and the electronically controlled air supply valve may be cast into a unified part to avoid needing aftermarket installation.

Further possible embodiments and/or features of the disclosed system may include one or more of the following: a power light on the control module to indicate to the driver that the power to the control module is on (or operational) and the control module is activated and ready for use; a ready light on the control module to indicate to the driver that the control module is ready and activated; a deploy light on the control module to indicate to the driver that the control module is used; a system override switch disposed on the control module and configured for operable engagement by the driver in a circumstance when the system for the remote actuation of a parking brake is deactivated temporarily; the control module is further configured to prevent disengagement of the parking brake unless the remote actuation device is present; the remote actuation device is an electronic card configured for electronic communication with the actuator; the remote actuation device is an RFID card configured for detection by the control module; a controller disposed within the control module and configured for communication with the remote actuation device; and a sensor disposed within the control module and configured to detect the remote actuation device.

Further possible embodiments and/or features of the disclosed method may include one or more of the following: communicating a status to the actuator in the vehicle from the remote actuation device with the driver; engaging the parking brake by the control module; overriding the automatic system by a system override switch; utilizing an electronic card for the remote actuation device for electronic communication with the control module; utilizing an RFID card for a remote actuation device for detection by the control module; sending a signal from the remote actuation device to the control module; sending a signal from the control module to the remote actuation device; and preventing disengagement of the parking brake unless the remote activation device is present.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1A is a plan diagram of an exemplary embodiment of a pressure releasing valve of the system of the disclosure, the pressure releasing valve in a first position;

FIG. 1B is a plan diagram of a second position of the exemplary valve;

FIG. 2 is a plan diagram of the exemplary valve and parking brake of the disclosure;

FIG. 3 is a plan diagram of a potentially preferred embodiment of the system, which includes the valve, an actuator, and a driver device; and

FIG. 4 is a flow diagram showing steps in an exemplary method of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

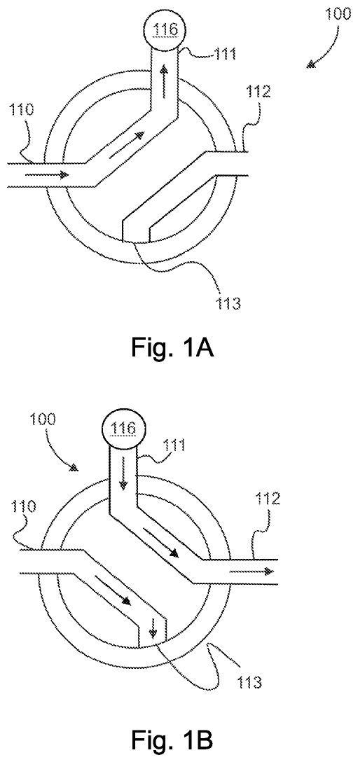

Referring now to FIGS. 1-4, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available devices and methods of ensuring a parking brake of an unoccupied vehicle having an air braking system is set.

Referring specifically to FIGS. 1A-1B, therein illustrated is a plan diagram of an exemplary embodiment of a pressure releasing valve which may be coupled or operably combined with valve control module 100 of the system of the disclosure, the pressure releasing valve in a first position (1A) and a second position (1B). The technology illustrated therein FIGS. 1A-1B and described herein provides a system for the remote actuation of a parking brake in a vehicle, thereby ensuring that the parking brake of the vehicle is set when the driver exits the vehicle to aid in the prevention of a rollaway vehicle accident, or other dangerous or otherwise scenario where a parking brake can and/or should be applied.

Beginning at FIG. 1A, various details of the disclosed system are illustrated therein FIG. 1B and described herein. Specifically, valve control module 100 may be an electronically controlled pressure valve having a motorized drive which can be actuated via any manner of automatically, electronically, or manually means. Starting at compressed air supply 110, a pneumatic connection may be made from an air brake air supply to valve control module 100. In the first position, air may then be supplied to park brake control button 116 via a subsequent pneumatic connection to compressed air parking brake connection 111. It is understood that this connection may exist on many vehicles therebetween an air supply and park brake control button 116, and that a pneumatic connection may be tapped into for installation of valve control module 100 on many of these existing vehicle systems. In this first position as illustrated herein, the existing pneumatic systems and the air and pressure supplied thereto remains unchanged from existing systems as are known to those having skill in the art, and the pop-up feature of a parking brake system would not be deployed because the system remains with normal operating pressure. In this first position, air cutoff 113 is simply connected to air vent 112 and each of air cutoff 113 and air vent 112 may experience atmospheric pressure.

Turning to FIG. 1B, various details of the disclosed system are illustrated therein FIG. 1B and described herein. Specifically, valve control module 100 may be an electronically controlled pressure valve having a motorized drive which can be actuated via any manner of automatic, mechanical, electronic, or manual means. As illustrated for exemplary purposes only, valve control module 100 may be simply rotated one quarter turn (90°) via actuation in order to achieve the cutoff, pressure release, and brake setting as herein described. Other known mechanisms for valve opening and closing may be substituted, as may be known to those having ordinary skill in the art, such as by way of example and not limitation: quarter-, half-, or multi-turn valves, ball valve, butterfly valve, check valve, gate valve, knife gate valve, globe valve, needle valve, pinch valve, plug valve, pressure relief valve, isolation valve, regulation valve, safety relief valve, non-return valve, special purpose valve, the like and/or various combinations thereof. Connections may include any known or yet-to-be-discovered connections for pneumatics, including but not limited to screwed, threaded, butt welded, socket welded, wafer, lug, compression fit, the like and/or combinations thereof. In the second position, compressed air is still supplied to valve control module 100 via compressed air supply 110, but instead of additionally being supplied to compressed air parking brake connection 111 via valve control module 100, it is suspended or cut off via air cutoff 113. Then, at compressed air parking brake connection 111, now connected via valve control module 100 to air vent 112, air is vented or released and the pneumatic system formed along air vent 112 to park brake control button 116 experiences a drop in pressure to atmospheric pressure, thereby causing a chain of events leading to the setting of the parking brake of the vehicle.

As may be understood by those having ordinary skill in the art, FIGS. 1A-1B may illustrate one configuration of a pneumatic valve capable of providing the features and benefits as herein described, though the disclosure is not so limited. Other means and/or valves may be substituted according to the principles and techniques known to those skilled in the art. By way of example and not limitation, the valve may be electronic and/or mechanical and move from a first position to a second in order to redirect air pressure in a system of the disclosure, the valve may be a pneumatic three-way, two position direction control valve, the valve may be a two- or three-way directional control pneumatic valve, the valve may be a spring offset pneumatic valve, the like and/or combinations thereof. No specific operating pressure, pressure range, operating medium, flow capacity, response time, cycle rate, coil rated voltage, and/or port size are contemplated herein except for those relevant to the systems and methods of the disclosure.

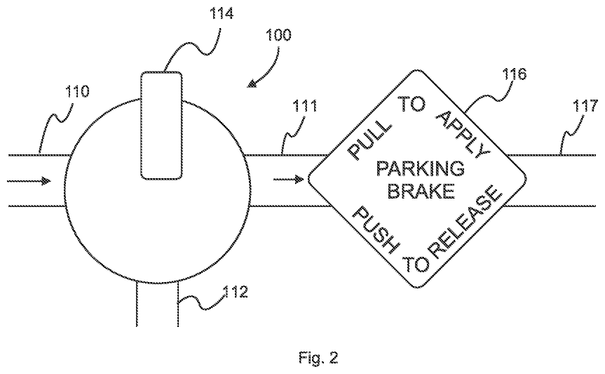

Referring specifically to FIG. 2, therein illustrated is a plan diagram of the exemplary valve control module 100 and parking brake control knob 116 of the disclosure. Various details of the disclosed system are illustrated therein FIG. 2 and described herein. Specifically, valve control module 100 having compressed air parking brake connection 111 to park brake control button 116 is therein illustrated. As illustrated therein, air pressure may be supplied to valve control module 100 via compressed air supply 110 and interceding into the known, existing pneumatic connection to park brake control button 116. As illustrated thereon valve control module 100, actuator 214 may cause valve control module 100 to spin and/or move between the first and second positions illustrated in FIGS. 1A-1B. In the first position, normal operation causes air to be supplied from compressed air supply 110 through valve control module 100 and to park brake control button 116 via compressed air parking brake connection 111. In this position, the parking brake may be released and/or not engaged via the pop-out feature of park brake control button 116. In the second position, this connection may be cut off and/or sealed such that park brake control button 116 no longer receives air pressure and may in fact vent via air vent 112 from park brake control button 116 via valve control module 100. In either case, park brake control button outlet 117 may experience air pressure comporting with park brake control button 116, and park brake control button outlet 117 may in fact simply be a termination or seal of the pneumatic system as herein disclosed or may instead supply air pressure to another aspect of the pneumatic system.

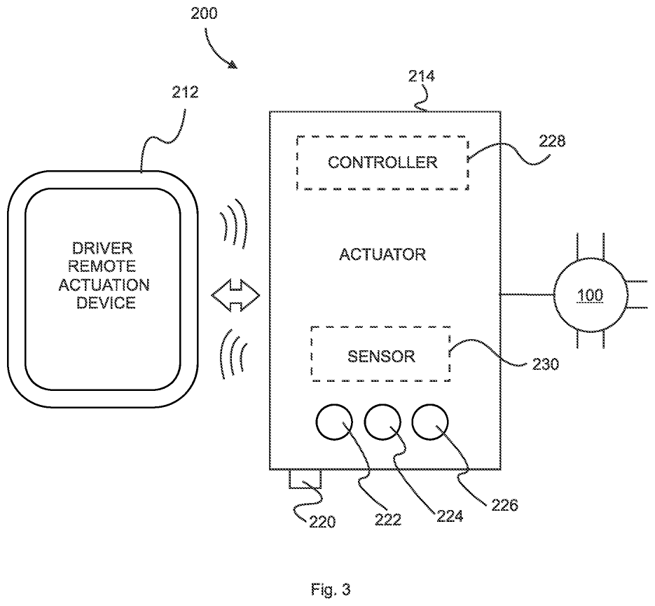

Referring specifically to FIG. 3, therein illustrated is a plan diagram of a potentially preferred embodiment of the system, which includes valve control module 100, actuator 214, and remote actuation device 212. The technology illustrated therein and described herein, in combination, provides system 200 for the remote actuation of a parking brake in a vehicle, thereby ensuring that the parking brake of the vehicle is set when the driver exits the vehicle to aid in the prevention of a rollaway vehicle accident, or other dangerous or otherwise scenario where a parking brake can and/or should be applied. System 200 includes an actuator 214 disposed within a vehicle equipped with air brakes and a park brake control button 116. In such vehicles, park brake control button 116 typically is operably combined with a pull-button, which may be pulled outwardly or lifted by the driver to set the parking brake, and park brake control button 116 (or the pull-button thereof) typically is pushed inwardly or depressed by the driver to disengage the parking brake. Actuator 214 may be coupled to park brake control button 116 such that it is configured to set the parking brake of the vehicle upon the occurrence of a predetermined event. The predetermined event, is for example, when a driver exits the vehicle neglecting to first set the parking brake. In at least one embodiment, actuator 214 is an electro-mechanical device that can mechanically move valve control module 100, causing the chain of events as described above. Additionally, actuator 214 may be an inseparable component of valve control module 100 or may be manufactured as part of a unified assembly. Actuator 214 may be simply a means for the electronic communication between valve control module 100 and remote actuation device 212. System 200 may further include remote actuation device 212. Remote actuation device 212 may be configured to be with the driver of the vehicle, such as an RFID card in a wallet or a similar feature built into a key. Remote actuation device 212 may be configured to indicate to actuator 214 when the driver exits the vehicle such that actuator 214 sets the parking brake if not already set. In at least one embodiment, actuator 214 may be placed on a dashboard such that it is easily coupled to park brake control button 116. System 200 may further include a series of lights, which may include by example and not limitation: power light 222, ready light 224, deploy light 226, the like and/or combinations thereof. Power light 222 on actuator 214 may be configured to indicate to the driver that the power to actuator 214 (or also and/or separately to valve control module 100) is on and actuator 214 and/or valve control module 100 is activated and ready for use. Ready light 224 on actuator 214 may be configured to indicate to the driver that the actuator is ready and activated. Deploy light 226 on actuator 214 may be configured to indicate to the driver that actuator 214 and/or valve control module 100 is currently being used in order to vent air from park brake control button 116 to atmosphere. System 200 may also include system override switch 220. System override switch 220 may disposed on actuator 214 and/or on valve control module 100. System override switch 220 may configured for operable engagement by the driver in a circumstance when the system for the remote actuation of a parking brake is deactivated temporarily. By way of example and not limitation, a driver may wish to override system 200 utilizing system override switch 220 when towing another vehicle or when being towed. Actuator 214 may be further configured to prevent disengagement of the parking brake unless remote actuation device 212 is present. For example, should a driver enter a vehicle in which the parking brake is set, but while not having remote actuation device 212 present, and thereby begin to disengage the parking brake, actuator 214 may disallows the disengagement of the parking brake since the safety system is defeated if the driver is without the remote actuation device 212. As may be understood by those having ordinary skill in the art, this may add additional safety and security to system 200 and may prevent use when a driver forgets the remote actuation device 212. Furthermore, a thief having access to only a vehicle key and/or capable of engaging a vehicle absent a key (e.g., hotwiring) may be prevented from moving the vehicle easily with the parking brake engaged. Remote actuation device 212 may be an electronic card configured for electronic communication with actuator 214. In such an embodiment, remote actuation device 212 may be configured for electronic communication with the actuator 214. The presence of remote actuation device 212 may then be recognizable by actuator 214. Alternatively, remote actuation device 212 may be an RFID card configured for detection by actuator 214. In such embodiments, remote actuation device 212 may be configured for electronic communication with actuator 214. The presence of remote actuation device 212 in these embodiments may also be recognizable by actuator 214. Both active and passive RFID cards may be utilized in the system 200 in various embodiments. Furthermore, remote actuation device 212 may simply be a computing device (e.g., smart phone) running an application for communication with actuator 214.

In at least one embodiment of this potentially preferred embodiment, system 200 may further include controller 228. Controller 228 may be disposed within actuator 214 or within valve control module 100 and may be configured for communication with remote actuation device 212. In variations of this proposed embodiment, controller 228 may include a processor, a memory, and a means for storing data, but may further include an RFID reader/antenna or electronic components which can operably communicate with a key FOB. Furthermore, in at least some embodiments of such a potentially preferred system 200, system 200 may also include sensor 230. Sensor 230 may be disposed within actuator 214 or may be built into valve control module 100 and may be configured to detect remote actuation device 212. Sensor 230 may be an RFID sensor which can be detected by an RFID reader/antenna at actuator 214.

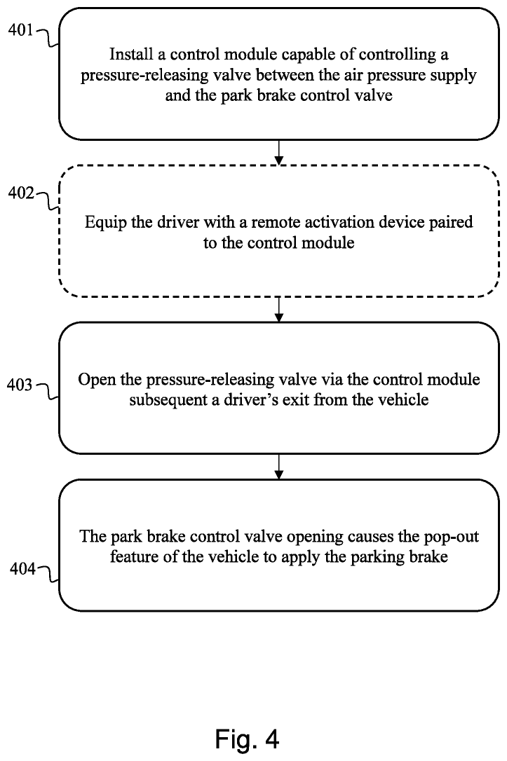

Referring specifically to FIG. 4, therein illustrated is a flow diagram showing steps in an exemplary method of the disclosure. As will be apparent to one of ordinary skill in the art, upon reading this disclosure, some of the method steps depicted in FIG. 4 may be implemented in varying order depending on the given circumstances. Additionally, one or more method steps depicted in the Figures may be omitted or substituted under the appropriate circumstances.

Beginning at step 401, a vehicle may be equipped with valve control module 100. Step 401 may presume that the vehicle is equipped with an air braking system and a parking brake pop-out control button (e.g., park brake control button 116). A pneumatic connection therebetween compressed air supply 110 of the air braking system and park brake control button 116 then exists in order to activate the pop-out feature to engage the parking brake during emergencies where air pressure to the brakes is suddenly lost, as described in detail above. By installing valve control module 100 between this existing connection, park brake control button 116 may be utilized to mimic such an occurrence, but instead when a driver leaves the vehicle. By way of example, but not of limitation, a vehicle dashboard may be equipped such that actuator 214 or valve control module 100 may be mounted adjacent to parking brake button of park brake control button 116 so that it can be reasonably assembled into an existing vehicle system. At step 402, a vehicle driver may be optionally equipped with remote actuation device 212. This step 402 may include utilizing remote actuation device 212 configured to be with the driver of the vehicle, or on the driver in some form, and to indicate to the actuator when the driver exits the vehicle such that the actuator sets the parking brake if not already set. At step 402, the remote actuation device 212 may also be paired to actuator 214 and/or simply valve control module 100 or the system may be manufactured as inseparably paired. Step 402 may include pairing actuator 214/valve control module 100 to remote actuation device 212 for communication between the devices. By way of example, and not of limitation, the pairing may be through a wireless technology protocol, such as Bluetooth®, or through RFID technology, whether active or passive. Other means of electronic, wireless communication between the actuator 214 and the remote actuation device 212 are utilized in various embodiments. At step 403, the departure of remote actuation device 212 (or detection of a driver exit via other means such as a weight sensor in a seat) may be identified by actuator 214 or valve control module 100. Upon this occurrence at step 403, valve control module 100 may be turned or otherwise actuated to vent air pressure from park brake control button 116, causing step 404 to occur and the pop-out feature of the vehicle will apply the parking brake via park brake control button 116. At various steps and/or stages of the disclosed method, various features illustrated and described in FIGS. 1-3 may also be implemented to change this process accordingly, as may be understood by those having ordinary skill in the art.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. An automatic parking brake system for a vehicle having an air braking system in pneumatic combination with an air pressure supply, a parking brake, and a park brake control button having a pressure loss pop-out feature comprising:
a control module capable of controlling a pressure-releasing valve; and
said pressure-releasing valve having a pneumatic connection therebetween the air pressure supply and the park brake control button;
wherein said control module is configured to open said pressure-releasing valve subsequent a driver's exit from the vehicle, causing the park brake control button to apply the parking brake.

2. The system of claim 1, wherein the park brake control button is configured to engage the parking brake upon a decrease in air pressure within the air braking system.

3. The system of claim 2, wherein said decrease in air pressure is 30 psi or below.

4. The system of claim 1, further comprising a remote actuation device, said remote actuation device is configured to be with said driver of the vehicle.

5. The system of claim 4, wherein said remote actuation device is further configured to indicate to said control module when said driver exits the vehicle, thereby causing said control module to open said pressure-releasing valve.

6. The system of claim 5, wherein said remote actuation device is configured to wirelessly broadcast a signal to said control module.

7. The system of claim 5, wherein said remote actuation device further comprises an aperture which is configured to receive a key ring.

8. The system of claim 5, wherein said remote actuation device is built into a key of the vehicle.

9. The system of claim 5, wherein said remote actuation device is a computing device capable of pairing with the control module.

10. The system of claim 1, further comprising a status light and an ON/OFF switch capable of engaging and disengaging said control module, said status light indicates whether said control module is engaged, disengaged, activated, or inactivated.

11. A method of automatically engaging a vehicle parking brake of a vehicle having an air braking system in pneumatic combination with an air pressure supply, a parking brake, and a park brake control button having a pressure loss pop-out feature, the method comprising:
installing a control module capable of controlling a pressure-releasing valve having a pneumatic connection therebetween the air pressure supply and the park brake control button; and
opening the pressure-releasing valve via said control module subsequent a driver's exit from the vehicle, causing the park brake control button to apply the parking brake.

12. The method of claim 11, further comprising a step of pairing a remote actuation device with said control module.

13. The method of claim 12, wherein said remote actuation device is configured to be with a driver of the vehicle.

14. The method of claim 13, said remote actuation device is further configured to indicate to said control module when said driver exits the vehicle, thereby causing said control module to open said pressure-releasing valve.

15. The method of claim 14, wherein said remote actuation device is configured to wirelessly broadcast a signal to said control module.

16. The method of claim 15, wherein said remote actuation device is built into a key of the vehicle.

17. The method of claim 12, wherein said remote actuation device is a computing device capable of pairing with the control module.

18. The method of claim 11, wherein the park brake control button is configured to engage the parking brake upon a decrease in air pressure within the air braking system.

19. The method of claim 18, wherein said decrease in air pressure is 30 psi or below.

20. The method of claim 19, wherein said control module is configured to open the pressure-releasing valve to cause said decrease in air pressure.
